(19) United States
(12) Patent Application Publication
(10) Pub. No.: US 2012/0263326 A1
(43) Pub. Date: Oct. 18, 2012

(54) SPEAKER UNIT

(76) Inventor: Markus Wolff, Wedemark (DE)

(21) Appl. No.: 13/510,394

(22) PCT Filed: Nov. 19, 2010
(86) PCT No.: PCT/EP2010/067816

§ 371 Date: Jun. 29, 2012

(30) Foreign Application Priority Data
Nov. 19, 2009 (DE) 10 2009 046 889.7

(51) Int. Cl. H04R 1/20; H04R 1/02; H04R 25/00

(52) U.S. Cl. 381/152

(57) ABSTRACT

There is provided a loudspeaker unit having at least one loudspeaker and a bass reflex tube, which has a wall, a first open end, a central portion and a second open end (32). The first open end ends in the internal volume of the loudspeaker unit and the second open end is connected to the external volume. The bass reflex tube has at least one opening in its wall. The loudspeaker unit further has insulating material in the interior of the loudspeaker unit. The insulating material covers the at least one opening in the wall of the bass reflex tube. The insulating material represents a non-foam material

The present application claims priority from PCT Patent Application No. PCT/EP2010/067816 filed on Nov. 19, 2010, which claims priority from German Patent Application No. DE 10 2009 046 889.7 filed on Nov. 19, 2009, the disclosures of which are incorporated herein by reference in their entirety.

### BACKGROUND OF THE INVENTION

1. Field of the Invention

The present invention concerns a loudspeaker unit.

2. Description of Related Art

It is noted that citation or identification of any document in this application is not an admission that such document is available as prior art to the present invention.

Loudspeaker units or loudspeaker boxes can have a bass reflex tube for improving bass reproduction.

DE 203 09 771 U1 discloses a loudspeaker unit having a bass reflex tube of circular, oval or polygonal cross-section. A first end of the bass reflex tube terminates with the outer housing of the loudspeaker box while the second end of the bass reflex tube projects into the interior of the volume of the loudspeaker unit. The bass reflex tube can have round bores.

EP 1 000 525 B1 discloses a loudspeaker unit having a bass reflex tube. The bass reflex tube can have bores in a central region thereof, which are surrounded by foam material. That foam material serves as a means for suppressing interference.

As general technological background attention is directed to FR 2 926 222 A1, JP 05-122786 A and JP 59-119678 U.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

Loudspeaker units with bass reflex tubes can involve problems with the natural frequency of the bass reflex tube. Therefore an object of the present invention is to provide a loudspeaker unit having a bass reflex tube which has reduced natural resonance of the bass reflex tube.

Thus there is provided a loudspeaker unit having at least one loudspeaker and a bass reflex tube, which has a wall, a first open end, a central portion and a second open end. The first open end ends in the internal volume of the loudspeaker unit and the second open end is connected to the external volume. The bass reflex tube has at least one opening in its wall. The loudspeaker unit further has insulating material in the interior of the loudspeaker unit. The insulating material covers the at least one opening in the wall of the bass reflex tube. The insulating material represents a non-foam material.

In an aspect of the invention the at least one opening is provided between the first and second ends.

In a further aspect of the invention the first end of the bass reflex tube is of a substantially triangular cross-section and/or the second end of the bass reflex tube is of a round cross-section.

In a further aspect of the invention the length-related flow resistance is between 5-45•10³ Ns/m⁴.

In a further aspect of the invention the specific flow resistance of the insulating material is between 8 and 1500 Ns/m³.

The present invention also concerns a loudspeaker unit having a loudspeaker and a bass reflex tube. The bass reflex tube has a wall, a first open end, a central portion and a second open end. The first open end ends in the internal volume of the loudspeaker unit and the second open end is connected to the external volume. The bass reflex tube has at least one opening in its wall. In addition a strip is arranged at least partly around the bass reflex tube in such a way that at least the at least one opening in the wall is covered. The material of the strip represents optionally or by way of example cloth, textile and/or a woven material.

The present invention concerns the notion of using the insulating material of the loudspeaker unit which is already present, for covering openings in the wall of a bass reflex tube. As an alternative thereto the arrangement of the insulating material which is already present can be so modified that those openings of the bass reflex tubes are covered.

### BRIEF DESCRIPTION OF THE DRAWINGS

FIG. 1 shows a diagrammatic sectional view of a loudspeaker unit according to a first embodiment;

FIG. 2 shows a diagrammatic perspective view of a bass reflex tube according to a second embodiment; and

FIG. 3 shows a diagrammatic perspective view of a bass reflex tube according to a third embodiment.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

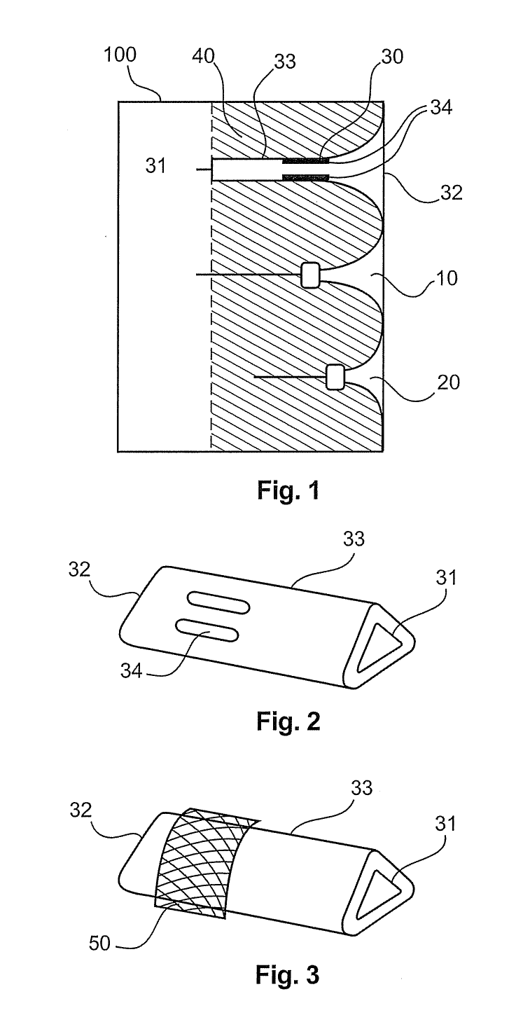

FIG. 1 shows a diagrammatic sectional view of a loudspeaker unit according to a first embodiment. The loudspeaker unit 100 has a first and optionally a second loudspeaker 10, 20 and a bass reflex tube 30. The bass reflex tube 30 has a first end 31 and a second end 32. The first end 31 ends in the internal volume of the loudspeaker unit 100 and the second end 32 is connected to the external volume. The bass reflex tube 30 further has a central portion 33 and at least one opening 34 between the first and second end 32.

The loudspeaker unit further has an insulating material 40 which also covers the at least one opening 34.

FIG. 2 shows a diagrammatic perspective view of a base reflex tube according to a second embodiment. The bass reflex tube has a first open end 31, a central portion 33 and a second open end 32. The bass reflex tube has two openings 33 disposed in the region between the first and second ends 31, 32. The openings 33 can be for example in the form of oval or elliptical holes.

The second end 32 is of a substantially circular cross-section. The first end 31 can optionally be of a substantially triangular cross-section.

FIG. 3 shows a perspective diagrammatic view of a bass reflex tube in accordance with a third embodiment. The bass reflex tube of the third embodiment substantially corresponds to that of the second embodiment. The bass reflex tube thus has a first open end 31, a central portion 33 and a second open end 32. The bass reflex tube further has two openings 34 in the wall, which are covered by an insulating material 50. The insulating material 50 optionally extends around the periphery of the bass reflex tube.

The insulating material of the first, second or third embodiment has a length-related specific flow resistance of 5•10³ Ns/m⁴-45•10³ Ns/m⁴. The specific flow resistance of an insulating material increases with increasing thickness of the layer. Therefore the length-related flow resistance is formed here as a material characteristic by reference to that layer thickness d[m] in the flow direction: r=Rs/d [Pa•s/m²=Ns/m⁴].

The specific flow resistance of the insulating material can be between 8 Ns/m³ and 1500 Ns/m³. That specific flow resistance is defined as the ratio of the pressure difference Δp [Pa] in front of and behind a material layer in relation to speed v [m/s] of the air flowing therethrough: Rs=Δp/v [Pa•s/m=Ns/m³].

The insulating material preferably represents a material which is not a foam material. Preferably an insulating material which is already present in the loudspeaker unit is used as the insulating material for covering the openings 34 in the bass reflex tube.

The insulating material of the first, second or third embodiment serves to avoid internal resonances within the loudspeaker unit. The insulating material can represent for example insulating wool, foam, sheep's wool, polyester wadding, cotton waste, cloth or fibers.

In a fourth embodiment which is also shown in FIG. 3 a cylindrical, optionally elastic strip for example in the form of a cloth, a woven material or a textile can be pushed over the bass reflex tube and in particular over the openings 34 in the wall. The material of that elastic or non-elastic strip preferably has the same length-related flow resistance and the same specific flow resistance of the insulating material of the first, second or third embodiment.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A loudspeaker unit comprising
at least one loudspeaker;
a bass reflex tube which includes:
a wall with at least one opening;
a first open end;
a central portion; and
a second open end;
wherein the first open end ends in the internal volume of the loudspeaker unit; and
wherein the second end is connected to the external volume; and
insulating material in the internal volume of the loudspeaker unit;
wherein the insulating material covers the at least one opening in the wall of the bass reflex tube;
wherein the insulating material represents a non-foam material; and
wherein the length-related flow resistance is between 5-45•10³ Ns/m⁴.

2. The loudspeaker unit as set forth in claim 1;
wherein the at least one opening is provided between the first and second ends.

3. The loudspeaker unit as set forth in claim 1;
wherein at least one of:
the first end of the bass reflex tube is of a substantially triangular cross-section; and
the second end of the bass reflex tube is of a round cross-section.

4. (canceled)

5. The loudspeaker unit as set forth in claim 1;
wherein the specific flow resistance of the insulating material is between 8 and 1500 Ns/m³.

6. A loudspeaker unit comprising:
at least one loudspeaker;
a bass reflex tube which includes:
a wall with at least one opening;
a first open end;
a central portion; and
a second open end;
wherein the first open end ends in the internal volume of the loudspeaker unit; and
wherein the second end is connected to the external volume; and
a strip which at least partially surrounds the bass reflex tube such that the at least one opening in the wall of the bass reflex tube is covered.

7. The loudspeaker unit as set forth in claim 6;
wherein a material of the strip is at least one of a cloth, a textile, and a woven material.

8. A loudspeaker unit comprising
at least one loudspeaker;
a bass reflex tube which includes:
a wall with at least one opening;
a first open end;
a central portion; and
a second open end;
wherein the first open end ends in the internal volume of the loudspeaker unit; and
wherein the second end is connected to the external volume; and
insulating material in the internal volume of the loudspeaker unit;
wherein the insulating material covers the at least one opening in the wall of the bass reflex tube;
wherein the insulating material represents a non-foam material; and
wherein the specific flow resistance of the insulating material is between 8 and 1500 Ns/m³.

9. The loudspeaker unit as set forth in claim 8;
wherein the at least one opening is provided between the first and second ends.

10. The loudspeaker unit as set forth in claim 2;
wherein the specific flow resistance of the insulating material is between 8 and 1500 Ns/m³.

11. The loudspeaker unit as set forth in claim 3;
wherein the specific flow resistance of the insulating material is between 8 and 1500 Ns/m³.
